(19) United States
(12) Patent Application Publication
(10) Pub. No.: US 2026/0317598 A1
(43) Pub. Date: Oct. 15, 2026

(54) Curable Precursors of Structural Adhesive Compositions Including Self-Polymerizable Toughening Agent, and Methods of Using Same

(71) Applicant: 3M INNOVATIVE PROPERTIES COMPANY, St. Paul, MN (US)

(72) Inventors: Boris O.A. Tasch, Dusseldorf (DE); Wayne S. Mahoney, St. Paul, MN (US); Adrian T. Jung, Kaarst (DE); Christian Heering, Dusseldorf (DE); Dirk Hasenberg, Raeren (BE)

(21) Appl. No.: 18/998,701

(22) PCT Filed: Jul. 18, 2023
(86) PCT No.: PCT/IB2023/057326

§ 371 Date: Jan. 27, 2025

Related U.S. Application Data
(60) Provisional application No. 63/399,771, filed on Aug. 22, 2022.

(51) Int. Cl. C09J 163/00; C09J 5/06

(52) U.S. Cl. CPC C09J 163/00; C09J 5/06; C09J 2301/408; C09J 2301/416

(57) ABSTRACT

Provided are curable precursors of structural adhesive compositions including epoxy resin, a thermally activatable curing agent, and toughening agents. One of the toughening agents includes a free-radically self-polymerizable material. Partially cured precursors are also provided in which the toughening agent includes a free-radically self-polymerization reaction product of the self-polymerizable material. Additionally, methods of manufacturing a structural adhesive article and bonding together two parts are provided.

### TECHNICAL FIELD

The present disclosure generally relates to curable compositions including toughening agents, cured compositions, and related methods.

### BACKGROUND

Structural adhesives are known to be useful for bonding one substrate to another, e.g., a metal to a metal, a metal to a plastic, a plastic to a plastic, a glass to a glass. Structural adhesives are attractive alternatives to mechanical joining methods, such as riveting or spot welding, because structural adhesives distribute load stresses over larger areas rather than concentrating such stresses at a few points. Structural adhesives may also produce cleaner and quieter products because they can dampen vibration and reduce noise. Additionally, structural adhesives can be used to bond a variety of materials, sometimes without extensive surface preparation.

### SUMMARY

In first aspect, a curable precursor of a structural adhesive composition is provided. The curable precursor comprises:
an epoxy resin;
a thermally activatable curing agent for the epoxy resin;
a first toughening agent; and
a second toughening agent comprising a free-radically self-polymerizable material represented by the formula:

$${LR}_{q}^{1}$$

wherein each R¹ is independently selected from a functional group represented by the formula:

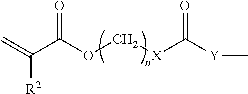

wherein:
   each R² is independently hydrogen or methyl;
   n is an integer from 1 to 5, inclusive;
   X is O, S, or NH; and
   Y is a single bond or a divalent group represented by the formula:

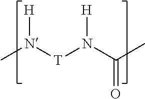

wherein:
   N′ is a nitrogen bonded to the carbonyl carbon of R¹; and
   T is a divalent group selected from the group consisting of a linear alkylene, a cyclic alkylene, an unsubstituted arylene, a substituted arylene, and combinations thereof;
   q is an integer of at least 2; and
   L is a q-valent organic polymer comprising a monomer unit represented by the formula:

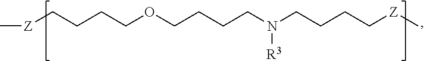

wherein R³ is a hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH.

In second aspect, a partially cured precursor of a structural adhesive composition is provided. The partially cured precursor comprises:
an epoxy resin;
a thermally activatable curing agent for the epoxy resin;
a first toughening agent; and
a second toughening agent comprising a self-polymerization reaction product of a free-radically self-polymerizable material represented by the formula:

$${LR}_{q}^{1}$$

wherein each R¹ is independently selected from a functional group represented by the formula:

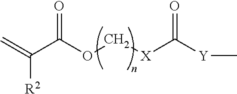

wherein:
   each R² is independently hydrogen or methyl;
   n is an integer from 1 to 5, inclusive;
   X is O, S, or NH; and
   Y is a single bond or a divalent group represented by the formula:

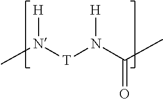

wherein:
   N′ is a nitrogen bonded to the carbonyl carbon of R¹; and
   T is a divalent group selected from the group consisting of a linear alkylene, a cyclic alkylene, an unsubstituted arylene, a substituted arylene, and combinations thereof;
   q is an integer of at least 2; and
   L is an q-valent organic polymer comprising a monomer unit selected from the group consisting of monomer units represented by the formula:

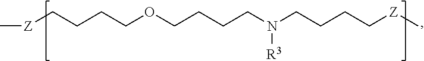

wherein R³ is hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH.

In a third aspect, a method of manufacturing a structural adhesive article is provided. The method comprises:
a) applying a curable precursor according to the first aspect onto a substrate;
b) partially curing the curable precursor of step a) by initiating a photoinitiator for the free-radically self-polymerizable material by actinic irradiation, thereby forming a partially cured precursor of a structural adhesive article comprising a polymeric material resulting from the self-polymerization reaction product of the free-radically self-polymerizable material; and
c) substantially fully curing the partially cured precursor of a structural adhesive article obtained in step b) by initiating the thermally activatable curing agent for the epoxy resin, thereby obtaining a substantially fully cured structural adhesive article.

In a fourth aspect, a method of bonding two parts is provided. The method comprises:
a) applying a curable precursor according to the first aspect or a partially cured precursor according to the second aspect to a surface of at least one of the two parts;
b) joining the two parts so that the curable precursor or the partially cured precursor is positioned between the two parts; and
c) substantially fully curing the partially cured precursor of step a) or c) by initiating the thermally activatable curing agent for the epoxy resin, thereby obtaining a substantially fully cured structural adhesive composition and bonding the two parts.

Features and advantages of the present disclosure will be further understood upon consideration of the detailed description as well as the appended claims.

### DETAILED DESCRIPTION

### Glossary

The term “alkyl” refers to a monovalent group that is a radical of an alkane, which is a saturated hydrocarbon. The alkyl can be linear, branched, cyclic, or combinations thereof and typically has 1 to 20 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene typically has 1 to 20 carbon atoms. The radical centers of the alkylene can be on the same carbon atom (i.e., an alkylidene) or on different carbon atoms.

The term “alkoxy” refers to a monovalent group of formula —OR where R is an alkyl.

The term “arylene” refers to a polyvalent, aromatic, such as phenylene, naphthalene, and the like.

The term “heteroalkylene” refers to an alkylene having one or more —CH₂— groups replaced with a thio, oxy, or —NR^{b}— where R^{b} is hydrogen or alkyl. The heteroalkylene can be linear, branched, cyclic, or combinations thereof. Exemplary heteroalkylene include alkylene oxides or poly(alkylene oxides). That is, the heteroalkylenes include at least one group of formula —(R—O)— where R is an alkylene.

The term “(meth)acrylate” or “(meth)acrylic acid” is used herein to denote the corresponding acrylate and methacrylate. Thus, for instance, the term “(meth)acrylic acid” covers both methacrylic acid and acrylic acid, and the term “(meth)acrylate” covers both acrylates and methacrylates. The (meth)acrylate or the (meth)acrylic acid may consist only of the methacrylate or methacrylic acid, respectively, or may consist only of the acrylate or the acrylic acid, respectively, yet may also relate to a mixture of the respective acrylate and methacrylate (or acrylic acid and methacrylic acid).

In the context of the present disclosure, the expression “free-radically self-polymerizable compound” is meant to refer to a compound able to form a polymeric product (homopolymer) resulting from the free-radically-induced polymerization of the compound almost exclusively with itself, thereby forming a homopolymer. In some cases, radiation exposure is used in the generation of free radicals. The term “homopolymer” is herein meant to designate polymer(s) resulting exclusively from the polymerization of a single type of monomers.

In the context of the present disclosure, the expression “the thermally curable resins are substantially uncured” is meant to designate that less than 10 wt. %, less than 5 wt. %, less than 2 wt. %, or even less than 1 wt. % of the initial curable resins are unreacted.

The terms “glass transition temperature” and “Tg” are used interchangeably and refer to the glass transition temperature of a (co) polymeric material or a mixture of monomers and polymers. Unless otherwise indicated, glass transition temperature values are determined by Differential Scanning calorimetry (DSC).

The phrase “comprises at least one of” followed by a list refers to comprising any one of the items in the list and any combination of two or more items in the list. The phrase “at least one of” followed by a list refers to any one of the items in the list or any combination of two or more items in the list.

As used herein, the term “and/or” is used to indicate one or both stated cases may occur, for example A and/or B includes, (A and B) and (A or B).

As used herein, the term “room temperature” refers to a temperature in the range of 20° C. to 25° C.

Epoxy adhesives are widely used structural adhesives having not only certain desirable mechanical properties but also a high resistance towards chemicals and aging. However, epoxy adhesives also tend to be rather brittle, which makes it necessary to further toughen them. These toughening agents or tougheners are typically based on the concept of phase separation within the epoxy matrix. Depending on the curing cycle, toughening can be achieved in-situ during a heat cure by using different polarities of polymers for example, or by introduction of separated phases in a form of core-shell rubber particles. For example, block-copolymers with epoxy end groups may be suitable as toughening agents.

It was unexpectedly discovered that the inclusion of a toughening agent comprising a self-polymerization reaction product of a free-radically self-polymerizable material represented by the formula LR¹_{q} as described in the present disclosure showed improved impact peel toughness not only at room temperature but also at −30° C. Vehicles (e.g., automobiles) may be used at such low ambient temperatures, thus higher impact peel toughness at low temperatures is desirable. It was further discovered that this increase in impact peel toughness occurs even if the toughening agent is not crosslinked prior to the heat cure of the epoxy adhesive.

### Curable Precursors

In a first aspect, the present disclosure provides a curable precursor of a structural adhesive composition. The curable precursor comprises:
an epoxy resin;
a thermally activatable curing agent for the epoxy resin;
a first toughening agent; and
a second toughening agent comprising a free-radically self-polymerizable material represented by the formula:

$${LR}_{q}^{1}$$

wherein each R¹ is independently selected from a functional group represented by the formula:

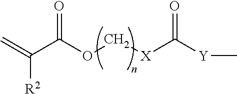

wherein:
   each R² is independently hydrogen or methyl;
   n is an integer from 1 to 5, inclusive;
   X is O, S, or NH; and
   Y is a single bond or a divalent group represented by the formula:

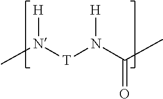

wherein:
   N′ is a nitrogen bonded to the carbonyl carbon of R¹; and
   T is a divalent group selected from the group consisting of a linear alkylene, a cyclic alkylene, an unsubstituted arylene, a substituted arylene, and combinations thereof;
   q is an integer of at least 2; and
   L is a q-valent organic polymer comprising a monomer unit represented by the formula:

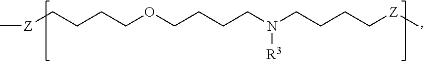

wherein R³ is a hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH.

Curable precursors of the present disclosure may be prepared by methods known to those of ordinary skill in the relevant arts. Each of the components of the curable precursor of a structural adhesive composition is described in detail below.

### Epoxy Resins

The curable precursor of a structural adhesive contains an epoxy resin. Epoxy resins are well known to those skilled in the art of structural adhesive compositions. Suitable epoxy resins for use herein and their methods of manufacturing are amply described for example in EP-A1-2 700 683 (Elgimiabi et al.) and in WO 2017/197087 (Aizawa). Exemplary epoxy resins for use herein may be advantageously selected from the group consisting of phenolic epoxy resins, bisphenol epoxy resins, hydrogenated epoxy resins, aliphatic epoxy resins, halogenated bisphenol epoxy resins, novolac epoxy resins, and any mixtures thereof. The epoxy resin for use in the present disclosure often comprises glycidyl groups.

In some cases, the epoxy resin is selected from the group consisting of novolac epoxy resins, bisphenol epoxy resins, in particular those derived from the reaction of bisphenol-A with epichlorhydrin (DGEBA resins), hydrogenated bisphenol epoxy resins, in particular those derived from the reaction of hydrogenated bisphenol-A with epichlorhydrin (hydrogenated DGEBA resins), and any mixtures thereof.

According to a typical aspect, the curable precursor according to the disclosure comprises from 2 to 50 wt. %, from 2 to 40 wt. %, from 3 to 40 wt. %, from 5 to 30 wt. %, from 10 to 30 wt. %, or even from 15 to 30 wt. %, of the epoxy resin(s), wherein the weight percentages are based on the total weight of the curable precursor.

### Thermally Activatable Curing Agents

Thermally activatable curing agents (e.g., initiators) for the curable precursor of the present disclosure are not particularly limited. Any thermally activatable curing agents for thermally curable epoxy resins commonly known in the art of structural adhesives may be used in the context of the present disclosure. Suitable thermally activatable curing agents for use herein may be easily identified by those skilled in the art in the light of the present disclosure.

Thermally activatable curing agents for use herein may be selected from the group consisting of rapid-reacting curing initiators, latent curing initiators, and any combinations or mixtures thereof. More typically, the thermal curing initiator for use herein may be selected from the group consisting of rapid-reacting thermally-initiated curing initiators, latent thermally-initiated curing initiators, and any combinations or mixtures thereof.

Suitable thermally activatable curing agent(s) may be selected from the group consisting of primary amines, secondary amines, and any combinations or mixtures thereof. In some cases, amines for use as a thermally activatable curing agent for the curable precursor are selected from the group consisting of aliphatic amines, cycloaliphatic amines, aromatic amines, aromatic structures having one or more amino moiety, polyamines, polyamine adducts, dicyandiamides, and any combinations or mixtures thereof.

According to still another advantageous aspect of the disclosure, the thermally activatable curing agent for use herein is selected from the group consisting of dicyandiamide, polyamines, polyamine adducts, and any combinations or mixtures thereof. In one preferred embodiment, the curing agent of the epoxy resin for use in the present disclosure is selected to be dicyandiamide.

In some cases, the curable precursor of the present disclosure further comprises a thermal curing accelerator for the thermally curable epoxy resin. Any thermal curing accelerators for thermally curable resins commonly known in the art of structural adhesives may be formally used in the context of the present disclosure. Suitable thermal curing initiators for use herein may be easily identified by those skilled in the art in the light of the present disclosure.

Thermally activatable curing agents and thermal curing accelerators are well known to those skilled in the art of structural adhesive compositions. Suitable thermally activatable curing agents and thermal curing accelerators for use herein and their methods of manufacturing are amply described for example in EP-A1-2 700 683 (Elgimiabi et al.) and in WO 2017/197087 (Aizawa).

In one advantageous execution, a suitable thermal curing accelerator for use herein is selected from the group consisting of polyamines, polyamine adducts, ureas, substituted urea adducts, imidazoles, imidazole salts, imidazolines, aromatic tertiary amines, and any combinations or mixtures thereof. A suitable thermal curing accelerator may be selected from the group of polyamine adducts, substituted ureas, in particular N-substituted urea adducts.

### First Toughening Agent

The curable precursor of the present disclosure comprises a first toughening agent. It is to be understood that the first toughening agent and the second toughening are not the same but rather are different materials from each other. The terms “first” and “second” (and optionally “third”, “fourth”, “fifth”, etc.) are used merely to distinguish between different toughening agents. First toughening agents which are useful in the present invention are polymeric compounds having both a rubbery phase and a thermoplastic phase such as: graft polymers having a polymerized, diene, rubbery core and a polyacrylate, polymethacrylate shell; graft polymers having a rubbery, polyacrylate core with a polyacrylate or polymethacrylate shell; and elastomeric particles polymerized in situ in the epoxide from free radical polymerizable monomers and a copolymerizable polymeric stabilizer.

Examples of useful toughening agents of the first type include graft copolymers having a polymerized, diene, rubbery backbone or core to which is grafted a shell of an acrylic acid ester or methacrylic acid ester, monovinyl aromatic hydrocarbon, or a mixture thereof, such as disclosed in U.S. Pat. No. 3,496,250 (Czerwinski), incorporated herein by reference. Preferable rubbery backbones comprise polymerized butadiene or a polymerized mixture of butadiene and styrene. Preferable shells comprising polymerized methacrylic acid esters are lower alkyl (C1-C4) substituted methacrylates. Preferable monovinyl aromatic hydrocarbons are styrene, alphamethylstyrene, vinyltoluene, vinylxylene, ethylvinylbenzene, isopropylstyrene, chlorostyrene, dichlorostyrene, and ethylchlorostyrene.

Examples of useful toughening agents of the second type are acrylate core-shell graft copolymers wherein the core or backbone is a polyacrylate polymer having a glass transition temperature below about 0° C., such as polybutyl acrylate or polyisooctyl acrylate to which is grafted a polymethacrylate polymer (shell) having a glass transition above about 25° C., such as polymethylmethacrylate.

The third class of toughening agents useful in the curable precursor comprises elastomeric particles that have a glass transition temperature (Tg) below about 25° C. before mixing with the other components of the curable precursor. These elastomeric particles are polymerized from free radical polymerizable monomers and a copolymerizable polymeric stabilizer that is soluble in the resins. The free radical polymerizable monomers are ethylenically unsaturated monomers or diisocyanates combined with coreactive difunctional hydrogen compounds such as diols, diamines, and alkanolamines.

Useful toughening agents include core/shell polymers such as methacrylate-butadiene-styrene (MBS) copolymer wherein the core is crosslinked styrene/butadiene rubber and the shell is polymethylacrylate (for example, ACRYLOID KM653 and KM680, available from Rohm and Haas, Philadelphia, PA), those having a core comprising polybutadiene and a shell comprising poly(methyl methacrylate) (for example, KANE ACE M511, M521, B11A, B22, B31, and M901 available from Kaneka Corporation, Houston, TX and CLEARSTRENGTH C223 available from ATOFINA, Philadelphia, PA), those having a polysiloxane core and a polyacrylate shell (for example, CLEARSTRENGTH S-2001 available from ATOFINA and GENIOPERL P22 available from Wacker-Chemie GmbH, Wacker Silicones, Munich, Germany), those having a polyacrylate core and a poly(methyl methacrylate) shell (for example, PARALOID EXL2330 available from Rohm and Haas and STAPHYLOID AC3355 and AC3395 available from Takeda Chemical Company, Osaka, Japan), those having an MBS core and a poly(methyl methacrylate) shell (for example, PARALOID EXL2691A, EXL2691, and EXL2655 available from Rohm and Haas) and the like and mixtures thereof.

In select embodiments, the first toughening agent comprises a core shell rubber.

The first toughening agent is useful in an amount equal to about 1-50 parts by weight, preferably about 3-25 parts by weight, relative to 100 parts by weight of total polymerizable components (including the epoxy resin) of the curable precursor.

### Second Toughening Agent

The curable precursor of the present disclosure comprises a second toughening agent. Second toughening agents of the present disclosure comprise a free-radically self-polymerizable material represented by the formula:

$${LR}_{q}^{1}$$

wherein each R¹ is independently selected from a functional group represented by the formula:

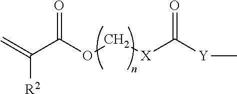

wherein:
each R² is independently hydrogen or methyl;
n is an integer from 1 to 5, inclusive;
   X is O, S, or NH; and
   Y is a single bond or a divalent group represented by the formula:

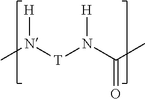

wherein:
N′ is a nitrogen bonded to the carbonyl carbon of R¹; and
T is a divalent group selected from the group consisting of a linear alkylene, a cyclic alkylene, an unsubstituted arylene, a substituted arylene, and combinations thereof;
q is an integer of at least 2; and
L is a q-valent organic polymer comprising a monomer unit represented by the formula a):

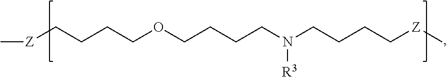

wherein R³ is a hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH.

In select embodiments, R³ is a (meth)acrylate and is a functional group of R¹.

With respect to q-valent organic polymer L, it is understood that L is a homopolymer as opposed to a block copolymer or a random copolymer. For example, a homopolymer would include only one type of monomer unit, e.g., a), b), c), or d) in the polymer chain. The q-valent organic polymer L typically comprises 100 wt. % of monomer unit a) monomers.

Without wishing to be bound by theory, it is believed that the branches of the free-radically self-polymerizable materials interpenetrate with the epoxy resin but do not react with the epoxy resin.

Free-radically self-polymerizable materials of the present disclosure represented by the formula LR¹_{q} (or L²R¹_{q}, L³R¹_{q}, L⁴R¹_{q}, etc., described below.) may be prepared by methods known to those of ordinary skill in the relevant arts and by methods as described, for example, in Cooper, S. L. and Guan, J. (Eds) Advances in Polyurethane Biomaterials, Chapter 4, (Elsevier Ltd., 2016) and Lin et al., “UV-curable low-surface-energy fluorinated poly(urethane-acrylates)s for biomedical applications,” European Polymer Journal, Vol. 44, pp. 2927-2937 (2008). For example, a crosslinker including monomer units represented by the formulas a) and b) may be prepared by the reaction of polyether polyprimary polyamines, either obtained from 3M Company (St. Paul, MN) under the trade designation DYNAMAR HC-1101 or prepared as described in U.S. Pat. No. 3,436,359 (Hubin et al.), with 2-isocyanatoethyl methacrylate (“IEM”).

In some embodiments, the q-valent organic polymer L has a number average molecular weight of from 4000 to 54000 grams per mole versus a polystyrene standard.

Curable precursors of the present disclosure generally include 2 wt. % or greater of the free-radically self-polymerizable materials described herein, based on the total weight of the curable precursor, 2.25 wt. %, 2.5 wt. %, 2.75 wt. %, 3 wt. %, 3.25 wt. %, 3.5 wt. %, 3.75 wt. %, 4 wt. %, 4.5 wt. %, or 5 wt. % or greater; and 10 wt. % or less, 9 wt. %, 8 wt. %, 7 wt. %, 6 wt. %, or 5 wt. % or less of the free-radically self-polymerizable materials described herein, based on the total weight of the curable precursor.

### Optional Components

The curable precursor according to the present disclosure optionally further comprises additional components, such as a photoinitiator, a reactive diluent, at least one additional toughening agent, and/or conventional additives. Additives may include, for example, tackifiers, plasticizers, dyes, pigments, antioxidants, UV stabilizers, corrosion inhibitors, dispersing agents, wetting agents, adhesion promotors, and fillers.

Fillers useful in embodiments of the present disclosure include, for example, fillers selected from the group consisting of a micro-fibrillated polyethylene, a fumed silica, a talc, a wollastonite, an aluminosilicate clay (e.g., halloysite), phlogopite mica, calcium carbonate, kaolin clay, metal oxides (e.g., barium oxide, calcium oxide, magnesium oxide, zirconium oxide, titanium oxide, zinc oxide), nanoparticle fillers (e.g. nanosilica, nanozirconia), and combinations thereof.

Suitable photoinitiators include for instance a free-radical polymerization initiator for the free-radically self-polymerizable second toughening agent, which may be activated by visible light. Free-radical polymerization initiators for the free-radically self-polymerizable second toughening agent are not particularly limited, as long as they may be activated by visible light. Suitable compounds for use herein may be easily identified by those skilled in the art in the light of the present disclosure.

Preferably, the photoinitiator is activated by light having wavelengths of at least 350 nm. Also, it is preferred that the photoinitiator is activated by light having wavelengths of up to 750 nm. Accordingly, it is preferred that the photoinitiator is activated by light having wavelengths in the range of from 350 nm to 750 nm, preferably from 380 to 700 nm, more preferably from 400 to 650 nm. That is, the photoinitiator may be activated by light having wavelengths in the range of from 380 to 450 nm, and/or from 450 to 485 nm, and/or from 485 to 500 nm, and/or 500 to 565 nm, and/or from 565 to 590 nm, and/or from 590 to 625 nm, and/or from 625 to 700 nm. Particularly preferred herein is blue light, i.e., light having wavelengths from 450 to 485 nm. For instance, the photoinitiator may be activated by light having wavelengths in the range of from (i) 450 to 485 nm, and optionally (ii) from 380 to 450 nm, from 485 to 500 nm, 500 to 565 nm, from 565 to 590 nm, from 590 to 625 nm, and/or from 625 to 700 nm. Thus, other wavelengths of the visible spectrum of light may be utilized.

According to a typical aspect of the disclosure, the photoinitiator of the free-radically self-polymerizable second toughening agent is selected from the group consisting of Norrish type (I) free-radical polymerization initiators, Norrish type (II) free-radical polymerization initiators, and any combinations or mixtures thereof. According to one advantageous aspect of the disclosure, the photoinitiator of the free-radically self-polymerizable second toughening agent is selected from the group consisting of Norrish type (I) free-radical polymerization initiators, and any combinations or mixtures thereof.

According to a more advantageous aspect of the disclosure, the free-radical polymerization initiator of the free-radically self-polymerizable second toughening agent is selected from alpha-diketones and/or phosphinoxides, preferably from camphorquinone, acylphosphinoxide, phenyl-propane-dione, acrylphosphinoxide, dibenzoyl, 1-phenyl-1,2-propandione, and any mixtures and combinations thereof. In some cases, the photoinitiator is preferably camphorquinone.

In one typical aspect, the curable precursor of the disclosure comprises no greater than 10 wt. %, no greater than 8 wt. %, no greater than 6 wt. %, no greater than 5 wt. %, no greater than 4 wt. %, no greater than 2 wt. %, no greater than 1 wt. %, no greater than 0.8 wt. %, no greater than 0.6 wt. %, no greater than 0.5 wt. %, no greater than 0.4 wt. %, no greater than 0.2 wt. %, or even no greater than 0.1 wt. %, of the photoinitiator of the free-radically self-polymerizable second toughening agent, wherein the weight percentages are based on the total weight of the curable precursor.

In another typical aspect, the curable precursor of the disclosure comprises from 0.01 to 10 wt. %, from 0.01 to 8 wt. %, from 0.02 to 6 wt. %, from 0.02 to 5 wt. %, from 0.02 to 4 wt. %, from 0.03 to 3 wt. %, from 0.03 to 2 wt. %, from 0.03 to 1.8 wt. %, from 0.03 to 1.6 wt. %, from 0.03 to 1.5 wt. %, from 0.03 to 1.4 wt. %, or even from 0.03 to 1 wt. %, of the photoinitiator of the free-radically self-polymerizable second toughening agent, wherein the weight percentages are based on the total weight of the curable precursor.

It may be advantageous to employ at least one reactive diluent in the curable precursor of the present disclosure. Photoinitiators as described herein may be better dissolved in such a reactive diluent than in the epoxy resin. Accordingly, it is preferred that any optional free-radical polymerization initiators are dissolved in an at least one reactive diluent before mixing with the other constituents of the curable precursor according to the present disclosure. Reactive diluents are known to the skilled person generally from the technical field of structural adhesives, in particular epoxy-resin based structural adhesives. Preferably, the at least one reactive diluent is selected from glycidyl ethers of linear or branched alkanol, preferably from diglycidyl ethers of linear or branched alkyldiols.

In some cases, the curable precursor contains at least one more toughening agent (e.g., a third toughening agent, a fourth toughening agent, etc.). For instance, an additional toughening agent may comprise a free-radically self-polymerizable material represented by the formula L²R¹_{q}, wherein R¹_{q} is the same as in LR¹, described in detail above and L² is a q-valent organic polymer L² comprising a monomer unit b) represented by the formula:

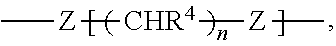

wherein n is an integer from 1 to 5, inclusive, each R⁴ is independently hydrogen or alkyl, and each Z is independently O, S, or NH.

In some cases, an additional toughening agent comprises a free-radically self-polymerizable material represented by the formula L³R¹_{q}, wherein R¹_{q} is the same as in LR¹_{q} described in detail above and L³ is a q-valent organic polymer L³ comprising a monomer unit c) represented by the formula:

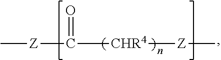

wherein n is an integer from 1 to 5, inclusive, each R⁴ is independently hydrogen or alkyl, and each Z is independently O, S, or NH.

In some cases, an additional toughening agent comprises a free-radically self-polymerizable material represented by the formula L⁴R¹_{q}, wherein R¹_{q} is the same as in LR¹_{q} described in detail above and L⁴ is a q-valent organic polymer L⁴ comprising a monomer unit d) represented by the formula:

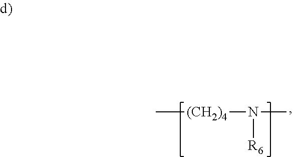

wherein R⁶ is hydrogen, a monomer unit selected from the group consisting of monomer units a)-c) or a Z-terminated alkyl chain, wherein the Z-terminated alkyl chain may include a linkage selected from the group consisting of a secondary amino linkage, a tertiary amino linkage, an ether linkage, and combinations thereof, and wherein Z is O, S, or NH, where it is understood that monomer units of formula d) are not located at a terminus of L if they are present.

### Partially Cured Precursors

In second aspect, the present disclosure provides a partially cured precursor of a structural adhesive composition. The partially cured precursor comprises:
an epoxy resin;
a thermally activatable curing agent for the epoxy resin;
a first toughening agent; and
a second toughening agent comprising a self-polymerization reaction product of a free-radically self-polymerizable material represented by the formula:

$${LR}_{q}^{1}$$

wherein each R¹ is independently selected from a functional group represented by the formula:

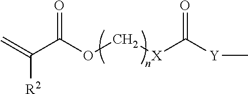

wherein:
   each R² is independently hydrogen or methyl;
   n is an integer from 1 to 5, inclusive;
   X is O, S, or NH; and
   Y is a single bond or a divalent group represented by the formula:

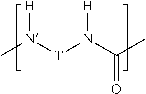

wherein:
   N′ is a nitrogen bonded to the carbonyl carbon of R¹; and
   T is a divalent group selected from the group consisting of a linear alkylene, a cyclic alkylene, an unsubstituted arylene, a substituted arylene, and combinations thereof;
   q is an integer of at least 2; and
   L is an q-valent organic polymer comprising a monomer unit selected from the group consisting of monomer units represented by the formula:

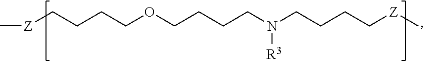

wherein R³ is hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH.

The partially cured precursor differs from the curable precursor of the first aspect described in detail above in that the second toughening agent comprises a self-polymerization reaction product of the free-radically self-polymerizable material. As such, the free-radically self-polymerizable material has been polymerized instead of being self-polymerizable. The self-polymerization reaction product of the free-radically self-polymerizable material may be formed by exposing the curable precursor to actinic radiation (e.g., UV radiation, visible radiation, e-beam radiation, or any combination thereof) and/or heat. Often, the partially cured precursor further comprises residual photoinitiator for the second toughening agent. Such residual photoinitiator is what portion of the photoinitiator included in the curable precursor that remains following exposure of the curable precursor to actinic radiation.

In all other respects, the components of the partially cured precursor (i.e., epoxy resin, thermally activatable curing agent, first toughening agent, second toughening agent, and optional component(s)) are as described in detail above with respect to the first aspect.

According to a typical aspect of the partially cured precursor according to the disclosure, the polymeric material comprising the self-polymerization reaction product of the free-radically self-polymerizable material is substantially fully polymerized and has in particular a degree of polymerization of more than 90%, more than 95%, more than 98%, or even more than 99%. As the polymeric material comprising the self-polymerization reaction product of the free-radically self-polymerizable material is substantially fully polymerized, this polymerization reaction has advantageously a fixed and irreversible end and will not trigger any shelf-life reducing reactions in the remainder of the curable precursor. This characteristic is believed to beneficially impact the overall shelf-life of the curable precursor.

In one advantageous aspect, the partially cured precursor according to the disclosure has a glass transition temperature (Tg) no greater than 0° C., no greater than −5° C., no greater than −10° C., no greater than −15° C., or even no greater than −20° C., when measured by DSC.

In another advantageous aspect of the disclosure, the partially cured precursor has an elongation at break of at least 50%, at least 80%, at least 100%, at least 150%, or even at least 200%, when measured according to tensile test DIN EN ISO 527. This particular property makes the partially cured precursor and the resulting structural adhesive suitable for automated handling and application, in particular by high-speed robotic equipment. More particularly, the partially cured precursor and the resulting structural adhesive of the present disclosure enables efficient automation of the process of forming a metal joint between metal plates.

### Methods

In a third aspect, a method of manufacturing a structural adhesive article is provided. The method comprises:
a) applying a curable precursor according to the first aspect onto a substrate;
b) partially curing the curable precursor of step a) by initiating a photoinitiator for the free-radically self-polymerizable material by actinic irradiation, thereby forming a partially cured precursor of a structural adhesive article comprising a polymeric material resulting from the self-polymerization reaction product of the free-radically self-polymerizable material; and
c) substantially fully curing the partially cured precursor of a structural adhesive article obtained in step b) by initiating the thermally activatable curing agent for the epoxy resin, thereby obtaining a substantially fully cured structural adhesive article.

The curable precursor is as described in detail above with respect to the first aspect, including any of the various embodiments described therein. The curable precursor is particularly suitable to perform an overall curing mechanism involving a two-stage reaction whereby two polymer networks are formed sequentially.

In a first stage reaction (B-stage), the free-radically self-polymerizable material self-polymerizes upon initiation by the free-radical polymerization initiator for the free-radically self-polymerizable material, thereby forming a polymeric material comprising the self-polymerization reaction product of a polymerizable material comprising the self-polymerizable material. Typically, the temperature T1 at which the free-radical polymerization initiator for the free-radically self-polymerizable multi-functional compound is initiated is insufficient to cause initiation of the thermally activatable curing agent of the thermally curable resin (i.e., the epoxy resin and any other curable materials, e.g., reactive diluent(s)). As a consequence, the first stage reaction typically results in a partially cured precursor, wherein the thermally curable resin(s) are substantially uncured and are in particular embedded into the polymeric material comprising the self-polymerization reaction product of the polymerizable material comprising the self-polymerizable material.

The first stage reaction which typically leads to a phase change of the initial curable precursor due in particular to the polymeric material comprising the self-polymerization reaction product of the self-polymerizable material providing structural integrity to the initial curable precursor, is typically referred to as a film-forming reaction. Advantageously, the first stage reaction does typically not require any substantial energy input.

The photoinitiator may be initiated by exposure to actinic radiation, such as by light having wavelengths in the range of from 350 nm to 750 nm as described in detail above with respect to suitable photoinitiators for the curable precursor. It is particularly advantageous when light of the visible spectrum of the light, in particular blue light, is used to activate the free-radical polymerization initiator, when compared to UV-light activation commonly utilized for initiating cure of adhesive in industrial applications. Not only is the penetration of visible light, in particular blue light, higher, the reaction tends to proceed much faster than with UV-A-light. While the former has the advantage that thicker films may be generated, the latter has the advantage that films may be generally manufactured faster. Also, EHS concerns using UV light at manufacturing sites may be avoided.

The partially cured precursor may typically take the form of a film-like self-supporting composition or a multi-dimensional object having a dimensional stability, which makes it possible for it to be pre-applied on a selected substrate, in particular a liner, until further processing. In select cases, the method above further comprises removing the partially cured precursor of a structural adhesive article obtained in step b) or the substantially fully cured structural adhesive article obtained in step c) from the substrate.

The partially cured precursor is typically provided with excellent characteristics and performance as to elasticity, tackiness, cold-flow and surface wetting. The free-radically self-polymerizable material of the second toughening agent is believed to play a critical role in obtaining the advantageous properties of the partially cured precursor as described above. Advantageously, the partially cured precursor may be appropriately shaped to fulfil the requirements of any specific applications.

The second stage reaction (A-stage) occurs after the first stage reaction and involves thermally curing the thermally curable resin(s) (i.e., the epoxy resin and any other curable materials, e.g., reactive diluent(s)) upon thermal initiation by the appropriate thermally activatable curing agent at a temperature T2 which is typically greater than the temperature T1. This reaction step typically results in forming a polymeric product resulting from the thermal curing of the thermally curable resin(s), in particular from the (co) polymerization of the thermally curable resin(s) and the thermally activatable curing agents of the thermally curable resin(s).

In the context of the present disclosure, the expression “substantially fully curing the curable precursor” or “substantially fully curing the partially cured precursor” is meant to express that more than 90 wt. %, more than 95 wt. %, more than 98 wt. %, or even more than 99 wt. % of the overall amount of the thermally curable resin(s) and the free-radically self-polymerizable material are polymerized/cured as the result of the polymerization/curing step(s).

The curable precursor of the present disclosure typically relies on the above-described dual/hybrid curing system involving two independent reactive systems activated with distinct triggering steps to ensure performing the above-described two-stage reaction in a sequential manner. Advantageously, the curable precursor of the present disclosure may be partially cured (or pre-cured) and pre-applied on a selected substrate before being finally cured in-place to produce a structural adhesive provided with excellent characteristics directly on the desired substrate or article.

According to one advantageous aspect, the curable precursor or the partially or fully cured structural adhesive composition of the present disclosure is shaped in the form of an elongated film. The elongated film shape is one conventional and convenient shape for the structural adhesive to be pre-applied on a selected substrate, in particular a liner, until further processing.

In one particular aspect of the disclosure, the elongated film for use herein has a thickness greater than 500 micrometers, greater than 600 micrometers, greater than 700 micrometers, greater than 800 micrometers, greater than 900 micrometers, or even greater than 1000 micrometers.

In another particular aspect of the disclosure, the elongated film for use herein has a thickness no greater than 500 micrometers, no greater than 400 micrometers, no greater than 300 micrometers, no greater than 200 micrometers, no greater than 100 micrometers, or even greater than 50 micrometers.

Although the elongated film shape may be convenient in many different applications, this specific shape is not always satisfactory for adhesively bond assemblies provided with complex three-dimensional configurations or topologies, in particular when provided with challenging bonding areas or surfaces.

Accordingly, the curable precursor or the partially or fully cured (hybrid) structural adhesive composition of the disclosure may—in another aspect—be shaped in the form of a three-dimensional object. Suitable three-dimensional object shapes for use herein will broadly vary depending on the targeted bonding application and the specific configuration of the assembly to bond, in particular the bonding area. Exemplary three-dimensional object shapes for use herein will be easily identified by those skilled in the art in the light of the present disclosure. According to one exemplary aspect of the present disclosure, the three-dimensional object has a shape selected from the group consisting of circular, semi-circular, ellipsoidal, square, rectangular, triangular, trapezoidal, polygonal shape, or any combinations thereof. In the context of the present disclosure, the shape of the three-dimensional object is herein meant to refer to the shape of the section of the three-dimensional object according to a direction substantially perpendicular to the greatest dimension of the three-dimensional object.

In yet another aspect, the present disclosure relates to a composite article comprising a curable precursor or a partially or fully cured (hybrid) structural adhesive composition as described above applied on at least part of the surface of the article. Suitable surfaces and articles for use herein are not particularly limited. Any surfaces, articles, substrates and material commonly known to be suitable for use in combination with structural adhesive compositions may be used in the context of the present disclosure.

In a typical aspect, the article for use herein comprises at least one part, in particular a metal or a composite material part. In an advantageous aspect, the composite article according to the disclosure is used for body-in-white bonding applications for the automotive industry, in particular for hem flange bonding of parts, more in particular metal or composite material parts; and for structural bonding operations for the aeronautic and aerospace industries.

In a fourth aspect, a method of bonding two parts is provided. The method comprises:
a) applying a curable precursor according to the first aspect or a partially cured precursor according to the second aspect to a surface of at least one of the two parts;
b) joining the two parts so that the curable precursor or the partially cured precursor is positioned between the two parts; and
c) substantially fully curing the partially cured precursor of step a) by initiating the thermally activatable curing agent for the epoxy resin, thereby obtaining a substantially fully cured structural adhesive composition and bonding the two parts.

According to an advantageous aspect of the method of bonding two parts, the two parts are metal parts. According to another advantageous aspect, the method of bonding two parts is for hem flange bonding of metal parts, wherein:
the partially cured precursor is shaped in the form of an elongated film;
the partially cured precursor film has a first portion near a first end of the precursor film and a second portion near the second end opposite to the first end of the precursor film;
the first metal part comprises a first metal panel having a first body portion and a first flange portion along a margin of the first body portion adjacent a first end of the first body portion;
the second metal part comprises a second metal panel having a second body portion and a second flange portion along a margin of the second body portion adjacent a second end of the second body portion;
wherein the method comprises the steps of:
a) adhering the partially cured precursor film to the first metal panel or second metal panel, whereby following adhering and folding, a metal joint is obtained wherein the partially cured precursor film is folded such that:
   i. the first portion of the partially cured precursor film is provided between the second flange of the second metal panel and the first body portion of the first metal panel, and
   ii. the second portion of the partially cured precursor film is provided between the first flange of the first metal panel and the second body portion of the second metal panel; and
b) substantially fully curing the partially cured precursor by initiating the thermal curing initiator for the thermally curable resin, thereby obtaining a substantially fully cured (hybrid) structural adhesive composition and bonding the metal joint.

According to still another advantageous aspect of the method of bonding two parts, a side of a first edge portion of the first metal part is folded back and a hem flange structure is formed so as to sandwich the second metal part, and the curable precursor or the partially cured precursor as described above is disposed so as to adhere at least the first edge portion of the first metal part and a first surface side of the second metal part to each other.

Methods of bonding two parts, in particular for hem flange bonding of metal parts, are well known to those skilled in the art of structural adhesive compositions. Suitable methods of bonding two parts for use herein are amply described e.g., in EP-A1-2 700 683 (Elgimiabi et al.) and in WO 2017/197087 (Aizawa).

In a particular aspect of the present disclosure, the substrates, parts and surfaces for use in these methods comprise a metal selected from the group consisting of aluminum, steel, iron, and any mixtures, combinations or alloys thereof. More advantageously, the substrates, parts and surfaces for use herein comprise a metal selected from the group consisting of aluminum, steel, stainless steel and any mixtures, combinations or alloys thereof. In a particularly advantageous execution of the present disclosure, the substrates, parts and surfaces for use herein comprise aluminum.

It has yet surprisingly been discovered that, in some executions, the curable precursor as described above is suitable for manufacturing structural adhesive compositions provided with excellent characteristics and performance as to adhesion to oily contaminated substrates, such as stainless steel and aluminum.

### SELECT EMBODIMENTS OF THE PRESENT DISCLOSURE

In a first embodiment is provided a curable precursor of a structural adhesive composition. The curable precursor comprises an epoxy resin; a thermally activatable curing agent for the epoxy resin; a first toughening agent; and a second toughening agent comprising a free-radically self-polymerizable material represented by the formula: LR¹_{q}; wherein each R¹ is independently selected from a functional group represented by the formula:

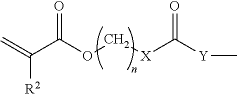

wherein each R² is independently hydrogen or methyl; n is an integer from 1 to 5, inclusive; X is O, S, or NH; and Y is a single bond or a divalent group represented by the formula:

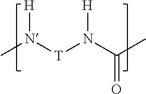

wherein N′ is a nitrogen bonded to the carbonyl carbon of R¹; and T is a divalent group selected from the group consisting of a linear alkylene, a cyclic alkylene, an unsubstituted arylene, a substituted arylene, and combinations thereof; q is an integer of at least 2; and L is a q-valent organic polymer comprising a monomer unit represented by the formula a):

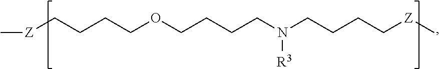

wherein R³ is a hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH.

In a second embodiment is provided a curable precursor according to the first embodiment, further comprising at least one reactive diluent.

In a third embodiment is provided a curable precursor according to the second embodiment, wherein the at least one reactive diluent comprises a glycidyl ether of a linear or branched alkanol.

In a fourth embodiment is provided a curable precursor according to any of the first through third embodiments, further comprising a photoinitiator activated by light having wavelengths in a range of from 350 nm to 750 nm.

In a fifth embodiment is provided a curable precursor according to any of the first through fourth embodiments, wherein the first toughening agent comprises a core shell rubber.

In a sixth embodiment is provided a curable precursor according to any of the first through fifth embodiments, wherein the thermally activatable curing agent for the epoxy resin is selected from the group consisting of dicyandiamide, polyamines, polyamine adducts, and any combination thereof.

In a seventh embodiment is provided a curable precursor according to any of the first through sixth embodiments, wherein the q-valent organic polymer L has a number average molecular weight of from 4000 to 54000 grams per mole versus a polystyrene standard.

In an eighth embodiment is provided a curable precursor according to any of the first through seventh embodiments, further comprising a third toughening agent comprising a free-radically self-polymerizable material represented by the formula L²R¹_{q}, wherein R¹, is the same as in LR¹_{q} and L² is a q-valent organic polymer L² comprising a monomer unit b) represented by the formula:

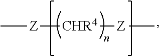

wherein n is an integer from 1 to 5, inclusive, each R⁴ is independently hydrogen or an alkyl, and each Z is independently O, S, or NH.

In a ninth embodiment is provided a curable precursor according to any of the first through eighth embodiments, further comprising a fourth toughening agent comprising a free-radically self-polymerizable material represented by the formula L³R¹_{q}, wherein R¹_{q} is the same as in LR¹_{q} and L³ is a q-valent organic polymer L³ comprising a monomer unit c) represented by the formula:

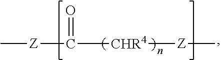

wherein n is an integer from 1 to 5, inclusive, each R⁴ is independently hydrogen or an alkyl, and each Z is independently O, S, or NH.

In a tenth embodiment is provided a curable precursor according to any of the first through ninth embodiments, further comprising a fifth toughening agent comprising a free-radically self-polymerizable material represented by the formula L⁴R¹_{q}, wherein R¹_{q} is the same as in LR¹_{q} and L⁴ is a q-valent organic polymer L⁴ comprising a monomer unit d) represented by the formula:

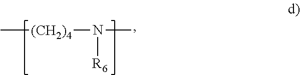

wherein R⁶ is hydrogen, a monomer unit selected from the group consisting of monomer units a)-c), or a Z-terminated alkyl chain, wherein the Z-terminated alkyl chain may include a linkage selected from the group consisting of a secondary amino linkage, a tertiary amino linkage, an ether linkage, and combinations thereof, and wherein Z is O, S, or NH.

In an eleventh embodiment is provided a curable precursor according to any of the first through tenth embodiments, wherein R³ is a (meth)acrylate and is a functional group of R¹.

In a twelfth embodiment is provided a curable precursor according to any of the first through eleventh embodiments, wherein the q-valent organic polymer L comprises 100 wt. % of monomer unit a) monomers.

In a thirteenth embodiment is provided a curable precursor according to any of the first through twelfth embodiments, wherein the second toughener is present in an amount of up to 10 wt. %, based on the total weight of the curable precursor.

In a fourteenth embodiment is provided a partially cured precursor of a structural adhesive composition. The partially cured precursor comprises an epoxy resin; a thermally activatable curing agent for the epoxy resin; a first toughening agent; and a second toughening agent comprising a self-polymerization reaction product of a free-radically self-polymerizable material represented by the formula: LR¹_{q}; wherein each R¹ is independently selected from a functional group represented by the formula:

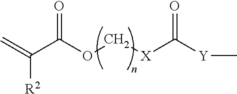

wherein each R² is independently hydrogen or methyl; n is an integer from 1 to 5, inclusive; X is O, S, or NH; and Y is a single bond or a divalent group represented by the formula:

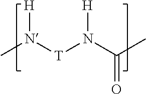

wherein N′ is a nitrogen bonded to the carbonyl carbon of R¹; and T is a divalent group selected from the group consisting of a linear alkylene, a cyclic alkylene, an unsubstituted arylene, a substituted arylene, and combinations thereof; q is an integer of at least 2; and L is an q-valent organic polymer comprising a monomer unit selected from the group consisting of monomer units represented by the formula:

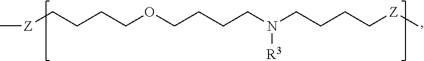

wherein R³ is hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH. In a fifteenth embodiment is provided a partially cured precursor according to the fourteenth embodiment, further comprising residual photoinitiator for the second toughening agent.

In a sixteenth embodiment is provided a method of manufacturing a structural adhesive article. The method comprises a) applying a curable precursor according to any of the first through thirteenth embodiments onto a substrate; b) partially curing the curable precursor of step a) by initiating a photoinitiator for the free-radically self-polymerizable material by actinic irradiation, thereby forming a partially cured precursor of a structural adhesive article comprising a polymeric material resulting from the self-polymerization reaction product of the free-radically self-polymerizable material; and c) substantially fully curing the partially cured precursor of a structural adhesive article obtained in step b) by initiating the thermally activatable curing agent for the epoxy resin, thereby obtaining a substantially fully cured structural adhesive article.

In a seventeenth embodiment is provided a method according to the sixteenth embodiment, further comprising removing the partially cured precursor of a structural adhesive article obtained in step b) or the substantially fully cured structural adhesive article obtained in step c) from the substrate.

In an eighteenth embodiment is provided a method of bonding two parts. The method comprises a) applying a curable precursor or a partially cured precursor according to any of the first through fifteenth embodiments to a surface of at least one of the two parts; b) joining the two parts so that the curable precursor or the partially cured precursor is positioned between the two parts; and c) substantially fully curing the partially cured precursor of step a) by initiating the thermally activatable curing agent for the epoxy resin, thereby obtaining a substantially fully cured structural adhesive composition and bonding the two parts.

In a nineteenth embodiment is provided a method according to the eighteenth embodiment, further comprising, prior to step c), partially curing the curable precursor of step a) by initiating a photoinitiator for the free-radically self-polymerizable material by actinic irradiation, thereby forming a partially cured precursor of a structural adhesive article comprising a polymeric material resulting from the self-polymerization reaction product of the free-radically self-polymerizable material.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

Materials Used in the Examples

| Abbreviation | Description and Source |
|---|---|
| KaneAce MX 153 | is a toughening agent, obtained from Kaneka Belgium N.V., Westerlo, |
| | Belgium. |
| KaneAce MX 257 | is a toughening agent, obtained from Kaneka Belgium N.V. |
| KaneAce B 564 | is a toughening agent, obtained from Kaneka Belgium N.V. |
| Epikote 828 | is an epoxy resin, obtained from Hexion Specialty Chemicals GmbH, |
| | Iserlohn, Germany. |
| Epikote 1001 | is a solid epoxy resin, obtained from Hexion Specialty Chemicals |
| | GmbH. |
| D-6000-DMA | D-6000-DMA is a dimethacrylate polyether oligomer having a number |
| | average molecular weight of about 6000 g/mol, and which is obtained |
| | from 3M Espe GmbH, Germany. |
| CN159 | is a dimethacrylate bisphenol A oligomer obtained from Sartomer, |
| | Colombes Cedex, France. |
| HC1101/IEM | is a free-radically self-polymerizable intermediate prepared generally |
| | according to the procedure described in Preparative Example 1 of WO |
| | 2020/250154. |
| Amicure CG-1200 | is a dicyandiamide-based latent curing initiator for epoxides, obtained |
| (DICY) | from Evonik, Essen, Germany. |
| Camphorquinone | is a photoinitiator, obtained from Sigma-Aldrich, St. Louis, MO, United |
| | States. |
| ipox RD24 | is a diluent for epoxies, obtained from ipox chemicals GmbH, |
| | Laupheim, Germany. |

### Test Methods for One Component Adhesives

### Preparation of the Formulations for Testing:

KaneAce MX 153, KaneAce MX 257, Epikote 1001 and KaneAce B 564 were placed in a beaker, which was placed in a high-speed mixer (DAC 150.1 FVZ Speedmixer, Hauschild Engineering, Germany) at 3500 rpm for 5 minutes. The mixture was allowed to cool down and the process was repeated several times until the solid parts were thoroughly homogenously mixed in. Then, Epikote 828 as well as ipox RD24 were added to the mixture and mixed in at 3500 rpm for 1 minute. Subsequently, a toughening agent comprising a free-radically self-polymerizable material as specified in Table 1, which in some cases had to be heated up to 80° C. to liquify, was mixed in, followed by dicyandiamide (DICY) and finally camphorquinone. The mixture was kept dark from there on to avoid premature cure of the B-stage or quenching of the camphorquinone.

TABLE 1

| | Formulation | | | | | | | |
|---|---|---|---|---|---|---|---|---|
| | Comparative | Comparative | Comparative | | | Comparative | | |
| Raw | Example 1 | Example 2 | Example 3 | Example 1 | Example 2 | Example 4 | Example 3 | Example 4 |
| materials | [wt. %] | [wt. %] | [wt. %] | [wt. %] | [wt. %] | [wt. %] | [wt. %] | [wt. %] |
| Epikote 828 | 6.29 | 5.94 | 5.94 | 5.94 | 5.98 | 7.77 | 7.33 | 5.63 |
| KaneAce | 31.45 | 29.71 | 29.71 | 29.71 | 29.90 | 29.14 | 27.49 | 28.14 |
| MX 153 | | | | | | | | |
| KaneAce | 31.45 | 29.71 | 29.71 | 29.71 | 29.90 | 29.14 | 27.49 | 28.14 |
| MX 257 | | | | | | | | |
| KaneAce B | 7.86 | 7.43 | 7.43 | 7.43 | 7.48 | 9.71 | 9.16 | 7.04 |
| 564 | | | | | | | | |
| ipox RD24 | 7.86 | 7.43 | 7.43 | 7.43 | 7.48 | 9.71 | 9.16 | 7.04 |
| Epikote | 9.43 | 8.91 | 8.91 | 8.91 | 8.97 | 0.00 | 0.00 | 8.44 |
| 1001 | | | | | | | | |
| Epikote | 0.00 | 0.00 | 0.00 | 0.00 | 0.00 | 7.77 | 7.33 | 0.00 |
| 1004 | | | | | | | | |
| Camphorquinone | 0.00 | 0.66 | 0.66 | 0.66 | 0.00 | 0.00 | 0.66 | 0.63 |
| Amicure | 5.66 | 5.22 | 5.22 | 5.22 | 5.26 | 6.74 | 6.38 | 4.95 |
| CG-1200 | | | | | | | | |
| (DICY) | | | | | | | | |

Secondary tougheners used:

| | | | | | | | | |
|---|---|---|---|---|---|---|---|---|
| D-6000- | 0.00 | 5.00 | 0.00 | 0.00 | 0.00 | 0.00 | 0.00 | 0.00 |
| DMA | | | | | | | | |
| CN159 | 0.00 | 0.00 | 5.00 | 0.00 | 0.00 | 0.00 | 0.00 | 0.00 |
| HC1101/IEM | 0.00 | 0.00 | 0.00 | 5.00 | 5.03 | 0.00 | 5.00 | 10.00 |

### Preparation of Test Samples:

After preparation of the formulations the material was extruded in shape of a film of 0.3 mm thickness between two sheets of PET Silphan liner by using a knife-coater. The extruded film was irradiated with a blue light LED array (10 cm×10 cm; 460 nm; commercially available from Dr. Göbel Opsitec) for 30 s until the B-stage reaction was complete.

### Preparation of the Test Samples for Overlap Shear Strength (OLS) Tests, T-Peel Tests and Impact Peel Tests:

The surfaces of OLS, T-peel and impact peel samples (steel, grade DC04 ZE 75 RL2027) were cleaned with n-heptane and coated with 3 g/m² of the testing oil (PL 3802-39S commercially available from Fuchs Petrolub AG, Germany). The test samples were left at ambient room temperature (23° C.+/−2° C., 50% relative humidity+/−5%) for 24 hours prior to testing and the OLS, T-peel and impact peel strengths were measured as described below.

### 1) Overlap Shear Strength (OLS) According to DIN EN 1465.

Overlap shear strength was determined according to DIN EN 1465 using a Zwick Z050 tensile tester (commercially available by Zwick GmbH & Co. KG, Ulm, Germany) operating at a cross head speed of 10 mm/min. For the preparation of an Overlap Shear Strength test assembly, the extruded film resulting from blue light irradiation was cut into a rectangular shape and applied onto one surface of a test panel to give a defined layer having a thickness of 0.3 mm. The sample was then covered by a second steel strip forming an overlap joint of 13 mm. The overlap joints were then clamped together using two binder clips and the test assemblies were further stored at room temperature for 4 hours after bonding, and then placed into an air circulating oven for 30 minutes at 180° C. The next day, the samples were tested. Five samples were measured for each of the examples and results averaged and reported in Megapascal (MPa).

### 2) T-Peel Strength According to DIN EN ISO 11339.

T-Peel strength was determined according to DIN EN ISO 11339 using a Zwick Z050 tensile tester (commercially available by Zwick GmbH & Co. KG, Ulm, Germany) operating at a cross head speed of 100 mm/min. For the preparation of a T-Peel Strength test assembly, the extruded film resulting from blue light irradiation was cut into a rectangular shape and applied onto one surface of a test panel to give a defined layer having a thickness of 0.3 mm. The second test panel surface was then bonded to the first forming an overlap joint of 100 mm. The samples were fixed together with clamps and first stored at room temperature for 12 hours, and then placed into an air circulating oven for 30 minutes at 180° C. The next day, the samples were tested. Three samples were measured for each of the examples and results averaged and reported in Newton (N).

### 3) Impact Peel Strength According to DIN EN ISO 11343.

Impact peel performance was determined according to DIN EN ISO 11343 using a Zwick HIT450P pendulum test machine (commercially available by Zwick GmbH & Co. KG, Ulm, Germany). For the preparation of the impact peel test assembly, the extruded film resulting from blue light irradiation was cut into a rectangular shape and applied onto one surface of a test panel to give a defined layer having a thickness of 0.3 mm. The second test panel surface was then bonded to the first forming a bonded joint of 30 mm. The samples were fixed together with clamps and first stored at room temperature for 12 hours, and then placed into an air circulating oven for 30 minutes at 180° C. The next day, the samples were tested. The substrates were bonded over a length of 30 mm and the free arms of the specimen were clamped. A wedge was drawn through the bonded portion of the specimen with a test rate of 2 m/s. The result was averaged and reported in N/mm indicating the adhesive resistance to crack growth influence of different temperatures. Per test ten samples were prepared; five of which were tested at room temperature, five at −30° C. Test results for the formulations are shown in Table 2.

As can be seen from the results shown in Table 2, the structural adhesives according to the present disclosure provide improved impact peel strength performance on oily contaminated substrates when compared to the comparative examples formulated without the second toughening agent comprising a free-radically self-polymerizable material. This improvement can be especially seen when testing at low temperatures (−30° C.), where the examples show only a slight drop in performance compared to testing at room temperature. In contrast, comparative examples 1 and 4 (not comprising any photoinitiated self-polymerizable monomer or any polymerization initiator thereof) expectedly show a significant loss of impact peel strength on oily contaminated substrates when the test is performed at low temperature and compared to the value at room temperature.

TABLE 2

| | OLS | T-peel | impact peel [N/mm] | impact peel |
|---|---|---|---|---|
| Formulation | [MPa] | [N] | @room temperature | [N/mm] @−30 °C |
| Comparative | 20.5 | 160 | 39.0 | 17.5 |
| Example 1 | | | | |
| Comparative | 19.0 | 212 | 31.7 | 25.6 |
| Example 2 | | | | |
| Comparative | 20.2 | 144 | 37.3 | 19.7 |
| Example 3 | | | | |
| Example 1 | 19.6 | 191 | 43.1 | 40.3 |
| Example 2 | 19.9 | 237 | 36.7 | 34.2 |
| Comparative | 22.1 | 301 | 43.6 | 17.2 |
| Example 4 | | | | |
| Example 3 | 20.6 | 236 | 41.4 | 37.6 |
| Example 4 | 17.7 | 232 | 38.8 | 36.6 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A curable precursor of a structural adhesive composition, comprising:
an epoxy resin;
a thermally activatable curing agent for the epoxy resin;
a first toughening agent; and
a second toughening agent comprising a free-radically self-polymerizable material represented by the formula:
$${LR}_{q}^{1}$$
wherein each R¹ is independently selected from a functional group represented by the formula: 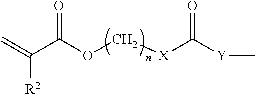
wherein:
each R² is independently hydrogen or methyl;
n is an integer from 1 to 5, inclusive;
X is O, S, or NH; and
Y is a single bond or a divalent group represented by the formula: 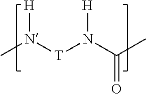
wherein:
N′ is a nitrogen bonded to the carbonyl carbon of R¹; and
T is a divalent group selected from the group consisting of a linear alkylene, a cyclic alkylene, an unsubstituted arylene, a substituted arylene, and combinations thereof;
q is an integer of at least 2; and
L is a q-valent organic polymer comprising a monomer unit represented by the formula a): 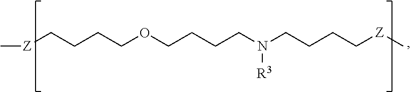
wherein R³ is a hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH.

2. The curable precursor of claim 1, further comprising at least one reactive diluent.

3. The curable precursor of claim 2, wherein the at least one reactive diluent comprises a glycidyl ether of a linear or branched alkanol.

4. The curable precursor of claim 1, further comprising a photoinitiator activated by light having wavelengths in a range of from 350 nm to 750 nm.

5. The curable precursor of claim 1, wherein the first toughening agent comprises a core shell rubber.

6. The curable precursor of claim 1, wherein the thermally activatable curing agent for the epoxy resin is selected from the group consisting of dicyandiamide, polyamines, polyamine adducts, and any combination thereof.

7. The curable precursor of claim 1, wherein the q-valent organic polymer L has a number average molecular weight of from 4000 to 54000 grams per mole versus a polystyrene standard.

8. The curable precursor of claim 1, further comprising a third toughening agent comprising a free-radically self-polymerizable material represented by the formula L²R¹_{q}, wherein R¹_{q} is the same as in LR¹_{q} and L² is a q-valent organic polymer L² comprising a monomer unit b) represented by the formula: 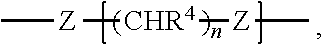
wherein n is an integer from 1 to 5, inclusive, each R⁴ is independently hydrogen or an alkyl, and each Z is independently O, S, or NH.

9. The curable precursor of claim 1, further comprising a fourth toughening agent comprising a free-radically self-polymerizable material represented by the formula L³R¹_{q}, wherein R¹_{q} is the same as in LR¹_{q} and L³ is a q-valent organic polymer L³ comprising a monomer unit c) represented by the formula: 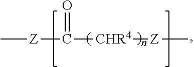
wherein n is an integer from 1 to 5, inclusive, each R⁴ is independently hydrogen or an alkyl, and each Z is independently O, S, or NH.

10. The curable precursor of claim 1, further comprising a fifth toughening agent comprising a free-radically self-polymerizable material represented by the formula L⁴R¹_{q}, wherein R¹_{q} is the same as in LR¹_{q} and L⁴ is a q-valent organic polymer L⁴ comprising a monomer unit d) represented by the formula: 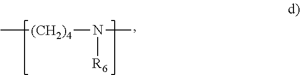
wherein R⁶ is hydrogen, a monomer unit selected from the group consisting of monomer units a)-c), or a Z-terminated alkyl chain, wherein the Z-terminated alkyl chain may include a linkage selected from the group consisting of a secondary amino linkage, a tertiary amino linkage, an ether linkage, and combinations thereof, and wherein Z is O, S, or NH.

11. The curable precursor of claim 1, wherein R³ is a (meth)acrylate and is a functional group of R¹.

12. The curable precursor of claim 1, wherein the q-valent organic polymer L comprises 5 wt. % to 20 wt. % of monomer unit a) monomers.

13. The curable precursor of claim 1, wherein the second toughener is present in an amount of up to 10 wt. %, based on the total weight of the curable precursor.

14. A partially cured precursor of a structural adhesive composition, comprising:
an epoxy resin;
a thermally activatable curing agent for the epoxy resin;
a first toughening agent; and
a second toughening agent comprising a self-polymerization reaction product of a free-radically self-polymerizable material represented by the formula:
LR¹_{q}
wherein each R¹ is independently selected from a functional group represented by the formula: 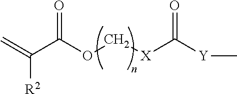
wherein:
each R² is independently hydrogen or methyl;
n is an integer from 1 to 5, inclusive;
X is O, S, or NH; and
Y is a single bond or a divalent group represented by the formula: 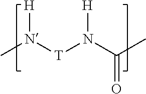
wherein:
N′ is a nitrogen bonded to the carbonyl carbon of R¹; and
T is a divalent group selected from the group consisting of a linear alkylene, a cyclic alkylene, an unsubstituted arylene, a substituted arylene, and combinations thereof;
q is an integer of at least 2; and
L is an q-valent organic polymer comprising a monomer unit selected from the group consisting of monomer units represented by the formula: 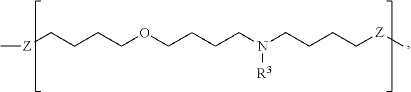
wherein R³ is hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH.

15. The partially cured precursor of claim 14, further comprising residual photoinitiator for the second toughening agent.

16. A method of manufacturing a structural adhesive article, the method comprising:
a) applying a curable precursor according to claim 1 onto a substrate;
b) partially curing the curable precursor of step a) by initiating a photoinitiator for the free-radically self-polymerizable material by actinic irradiation, thereby forming a partially cured precursor of a structural adhesive article comprising a polymeric material resulting from the self-polymerization reaction product of the free-radically self-polymerizable material; and
c) substantially fully curing the partially cured precursor of a structural adhesive article obtained in step b) by initiating the thermally activatable curing agent for the epoxy resin, thereby obtaining a substantially fully cured structural adhesive article.

17. The method of claim 16, further comprising removing the partially cured precursor of a structural adhesive article obtained in step b) or the substantially fully cured structural adhesive article obtained in step c) from the substrate.

18. A method of bonding two parts, the method comprising:
a) applying a curable precursor or a partially cured precursor according to claim 1 to a surface of at least one of the two parts;
b) joining the two parts so that the curable precursor or the partially cured precursor is positioned between the two parts; and
c) substantially fully curing the partially cured precursor of step a) by initiating the thermally activatable curing agent for the epoxy resin, thereby obtaining a substantially fully cured structural adhesive composition and bonding the two parts.

19. The method of claim 18, further comprising, prior to step c), partially curing the curable precursor of step a) by initiating a photoinitiator for the free-radically self-polymerizable material by actinic irradiation, thereby forming a partially cured precursor of a structural adhesive article comprising a polymeric material resulting from the self-polymerization reaction product of the free-radically self-polymerizable material.
